(19) United States
(12) Patent Application Publication
(10) Pub. No.: US 2015/0227371 A1
(43) Pub. Date: Aug. 13, 2015

(54) Processors with Support for Compact Branch Instructions & Methods

(71) Applicant: IMAGINATION TECHNOLOGIES LIMITED, Kings Langley (GB)

(72) Inventor: Ranganathan Sudhakar, Santa Clara, CA (US)

(21) Appl. No.: 14/612,069

(22) Filed: Feb. 2, 2015

Related U.S. Application Data
(60) Provisional application No. 61/939,066, filed on Feb. 12, 2014.

(51) Int. Cl. G06F 9/30

(52) U.S. Cl. CPC G06F 9/30058; G06F 9/30145

(57) ABSTRACT

Aspects relate to microprocessors, methods of their operation, and compilers therefor, that provide branch instructions with and without a delay slot. Branch instructions without a delay slot may have a forbidden slot. A processor, when decoding and executing a branch instruction without a delay slot, at a program counter location, executes an instruction in a subsequent program counter location (a “forbidden slot”, in some implementations) only if the branch is not taken. A pre-determined set of instruction types may be identified, and if an instruction location in the forbidden slot is from the pre-determined set of instruction types, implementations may throw an exception without executing the instruction, or may execute the instruction and throw an exception after execution. Such exceptions may be dependent or independent on an outcome of executing the instruction itself.

### CROSS REFERENCE TO RELATED APPLICATIONS

This application claims priority from U.S. Provisional Application No. 61/939,066, entitled “Processors with Support for Compact Branch Instructions & Methods” and filed on Feb. 12, 2014, and which is incorporated herein in its entirety for all purposes.

### BACKGROUND

1. Field

In one aspect, the following relates to microprocessor architecture, and in one more particular aspect, to microprocessor architectures and implementations thereof that support branches with a delay slot and branches without a delay slot.

2. Related Art

An architecture of a microprocessor pertains to a set of instructions that can be handled by the microprocessor, and what these instructions cause the microprocessor to do. Architectures of microprocessors can be categorized according to a variety of characteristics. One major characteristic is whether the instruction set is considered “complex” or of “reduced complexity”. Traditionally, the terms Complex Instruction Set Computer (CISC) and Reduced Instruction Set Computer (RISC) respectively were used to refer to such architectures. Now, many modern processor architectures have characteristics that were traditionally associated with only CISC or RISC architectures. In practicality, a major distinction of meaning between RISC and CISC architecture is whether arithmetic instructions perform memory operations.

A RISC instruction set may require that all instructions be exactly the same number of bits (e.g., 32 bits). Also, these bits maybe required to be allocated accordingly to a limited set of formats. For example, all operation codes of each instruction may be required to be the same number of bits (e.g., 6). This implies that up to 2̂6 (64) unique instructions could be provided in such an architecture. In some cases, a main operation code may specify a type of instruction, and some number of bits may be used as a function identifier, which distinguishes between different variants of such instruction (e.g., all addition instructions may have the same 6-digit main operation code identifier, but each different type of add instruction, such as an add that ignores overflow and an add that traps on overflow).

Remaining bits (aside from the “operation code” bits) can be allocated for identifying source operands, a destination of a result, or constants to be used during execution of the operation identified by the “operation code” bits). For example, an arithmetic operation may use 6 bits for an operation code, another 6 bits for a function code (collectively the “operation code” bits herein), and then identify one destination and two source registers using 5 bits each. Even though a RISC architecture may require that all instructions be the same length, not every instruction may require all bits to be populated, although all instructions still use a minimum of 32 bits of storage.

### SUMMARY

One aspect relates to circuitry for decoding instruction data into operations to be performed in a microprocessor. The circuitry comprises an input for instruction data and decode logic configured for interpreting portions of the instruction data as respective operations to be performed in the processor. Each portion of instruction data corresponds to a respective program counter location, the operations to be performed conform to an instruction set architecture that comprises a first set of branch instructions that have a delay slot, and a second set of branch instructions that do not have a delay slot. The decode logic is further configured to cause an instruction found in a program counter location directly after an instance of a branch instruction with a delay slot to be executed, regardless of an outcome of executing the instance of the branch instruction. The decode logic is further configured to cause an instruction found in a program counter location directly after an instance of a branch instruction without a delay slot to be executed, only if an outcome of executing the instance of the branch instruction without a delay slot does not branch around that instruction.

Branch instructions that may be supported both with and without delay slots include branch and link instructions, and branch immediate instructions. In one example, all instructions are represented by 32 bit values, and immediates may have sizes of 21 or 26 bits.

In some implementations, a processor containing such circuitry may produce an exception if the instruction found in the program counter location directly after the instance of a branch instruction without a delay slot is itself a branch instruction. In one implementation, some instruction types are classified as forbidden instruction types following a branch instruction without a delay slot. In some such implementations, forbidden instructions directly following a branch instruction without a delay slot may trigger an exception, while in other implementations, a forbidden instruction may be allowed to execute.

In another aspect, a processor has a decode unit coupled to a source of instruction data representing instructions to be executed in the processor. The decode unit is configured for interpreting portions of the instruction data as respective operations to be performed in the processor. Each portion of instruction data corresponds to a respective program counter location. The operations to be performed conform to an instruction set architecture that comprises a first set of branch instructions that have a delay slot, and a second set of branch instructions without a delay slot. The decode unit is further configured to cause, for each instance of a branch instruction with a delay slot, that an instruction found in a program counter location directly after that instance be executed without regard to an outcome of the branch instruction, and for each instance of a branch instruction without a delay slot, the decode unit further configured to execute the instruction found in a program counter location directly after that instance only if an outcome of the branch instruction does not branch around the instruction found in a program counter location directly after that instance of a branch instruction without a delay slot. The processor also comprises an execution unit to execute operations specified by instructions decoded by the decode unit.

Another aspect relates to a processor that has a decode unit coupled to a source of instruction data representing instructions to be executed in the processor. The decode unit is configured for interpreting portions of the instruction data as respective operations to be performed in the processor. Each portion of instruction data corresponds to a respective program counter location, and the operations to be performed conform to an instruction set architecture that comprises a type of branch instruction which has a forbidden slot, the forbidden slot is found at a program counter value directly following the program counter location of that branch instruction, and is associated with a pre-determined set of instruction types. An instruction scheduler is configured to allow execution of the instruction in the forbidden slot of that branch instruction to affect architectural state of the processor only if that branch instruction is taken and an execution unit configured to execute an operation specified by the instruction in the forbidden slot, and produce an exception if the instruction in the forbidden slot is an instruction according to any of the instruction types from the pre-determined set of instruction types.

In another aspect, a non-transitory machine readable medium storing instructions for executing a program compilation process, comprising: inputting a portion of source code, for which an object code is to be generated; identifying a location in the portion of source code in which a branch of control is to be inserted in a corresponding location in the object code; producing data representing the branch of control for insertion in the corresponding location in the object code; identifying an instruction for insertion in a location in the object code directly after the location where the branch of control was inserted, the identifying comprising excluding from consideration instructions from an enumerated set of forbidden instruction types and including only instructions that are on a code path that will be executed if the branch is not taken; and storing, on a non-transitory medium, machine readable data representing the identified instruction for insertion in the location in the object code directly after the location where the branch of control was inserted.

The program compilation process may operate in a just-in-time compiler, accepting byte code targeted to a virtual machine and outputting object code for execution on a specific microprocessor.

### BRIEF DESCRIPTION OF THE DRAWING

FIGS. 1A and 1B depict block diagrams pertaining to an example processor which can implement aspects of the disclosure;

FIG. 2 depicts an example process executed by a compiler (e.g., a pre-compiler or assembler, or a just-in-time compiler) to produce executable or interpretable code according to the disclosure;

FIG. 3 depicts an example block diagram of a compiler system according to the disclosure;

FIG. 4 depicts an example block diagram of a system that can include a virtual machine and a just in time compilation capability, which implement aspects of the disclosure;

FIG. 5 depicts a process of instruction decoding and performance according to aspects of the disclosure; and

FIG. 6 depicts components of an example system in which disclosed microprocessor aspects can be implemented.

### DETAILED DESCRIPTION

The following disclosure uses examples principally pertaining to a RISC instruction set, and more particularly, to aspects of a MIPS processor architecture. Using such examples does not restrict the applicability of the disclosure to other processor architectures, and implementations thereof.

Aside from the technical concerns, processor architecture design also is influenced by other considerations. One main consideration is support for prior generations of a given processor architecture. Requiring code to be recompiled for a new generation of an existing processor architecture can hinder customer adoption and requires more supporting infrastructure than a processor architecture that maintains backwards compatibility. In order to maintain backwards compatibility, the new processor architecture should execute the same operations for a given object code as the prior generation. This implies that the existing operation codes (i.e., the operation codes and other functional switches or modifiers of the new processor architecture cannot be changed).

One goal of a processor architecture and implementations thereof is to provide high utilization rates for available processing resources. Processor architectures have evolved over time to have complexity to realize that goal. One major advance was to allow multiple instructions to be processed in a multistage pipeline. One challenge in a pipelined processor is that some portions of instruction processing require more time than other portions. If each stage is clocked at a clock rate determined by the longest processing time, then there is lost processing opportunity for the pipeline portions that could be run faster. Techniques employed in modern architectures, such as adding more pipeline stages and out-of-order instruction processing.

However, before out-of-order processing techniques were widespread, another technique directed to improving pipeline utilization was to provide for a delay slot following instructions that required a relatively long time to complete. An example usage of a delay slot is for a next instruction location following a branch, which is either conditional, or requires resolution of a target address of the branch. The instruction in the delay slot is always executed, whether or not the branch is taken, even though it exists at a program counter location after that of the branch. The instruction in the delay slot thus is intended to be processed during a time when some portions of the processor would otherwise be idle waiting for the branch to resolve and begin processing. In order for this to work correctly and increase resource utilization rates, the delay slot must be filled with an instruction that can execute both on the taken and untaken path of the branch, or which otherwise has no dependencies on instructions for which results have not yet had their results committed, including the immediately preceding instruction. Some architectures have more than one delay slot, which means all instructions in these delay slots will execute regardless of any effect from executing the instruction having the delay slots. The responsibility for finding such instructions falls to a compiler, and in reality, many delay slots end up being filled with no op instructions rather than instructions that perform useful work. Also, delay slots introduce complications with respect to situations where other conditional instructions, such as branches may be in the delay slot.

For purposes of backwards compatibility, new generations of existing processor architectures should continue to support the same delay slot model as prior generations, or else incorrect results would occur. For example, if a new version of an existing processor architecture removed a delay slot from a position where one existed in a prior model, then an instruction in that location in an existing binary would not necessarily execute in the new architecture, while it would always have executed in previous architectures. However, modern computer architectures, especially those with branch prediction, and out of order instruction execution, often see little benefit from delay slots. As such, the present disclosure presents processor architectures and implementations thereof that implement compact branch instructions.

In this disclosure, a compact branch instruction is one that does not have a delay slot. A compact branch may instead have a forbidden slot, which is defined as an instruction scheduling opportunity that does not support scheduling of a branch instruction, and which is executed only if the program flow naturally reaches that instruction. Another approach to scheduling instructions for a forbidden slot is to allow any instruction in that location, but if the instruction is of an enumerated set of types, such as a branch or return, then an exception can be generated, or otherwise signalled.

For example, an addition can be located after a conditional branch (thus, in the “forbidden slot” following the branch). If the branch is taken, then the addition is not performed. If the branch is not taken, then the addition is performed. In one implementation, an attempt to locate another branch in the forbidden slot can be rejected by an assembler, and a compiler would not locate such an instruction in that location when processing source code.

Where compact branches are to be provided in a processor architecture that also supports branches with delay slots, each of these different branch types would be identified by a different operation code. Therefore, if compact branches are added to an existing processor architecture that supports branches with delay slots, then binaries compiled for that existing processor architecture would continue to execute on a processor supporting both branch types. Implementations of the disclosure include processors that support both branches with delay slots and compact branches, as well as processors that support only compact branches. The following presents more specific examples and details concerning implementations of processors that support such compact instructions.

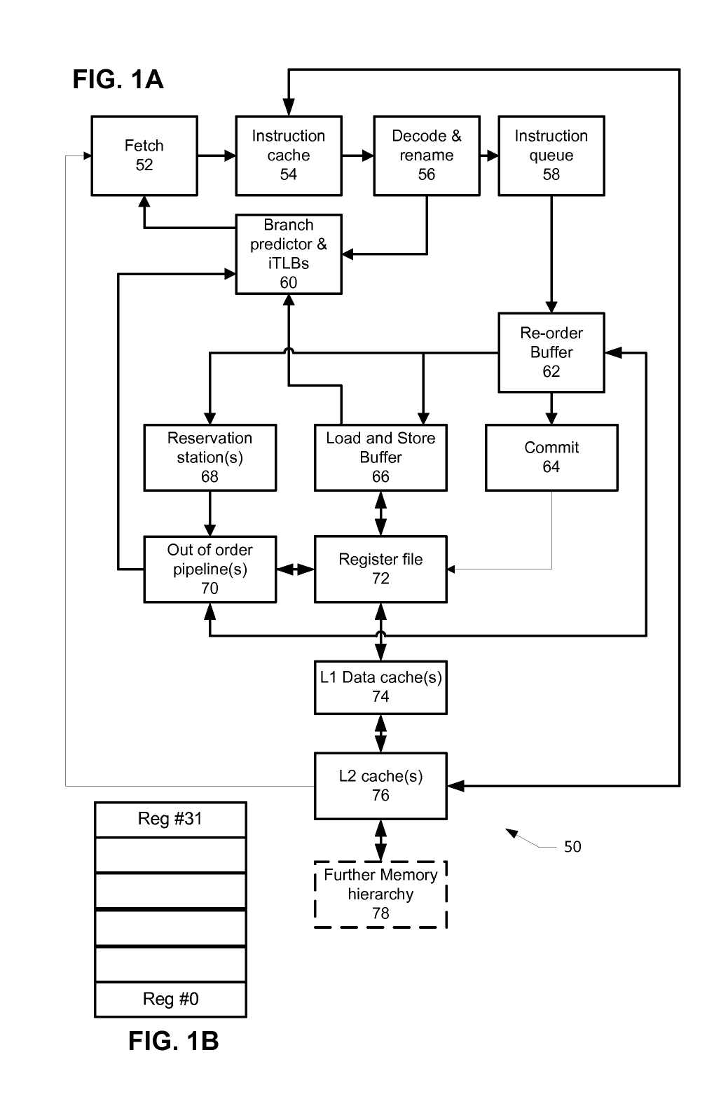

FIG. 1A depicts an example diagram of functional elements of a processor 50 that can implement aspects of the disclosure. The example elements of processor 50 will be introduced first, and then addressed in more detail, as appropriate. This example is of a processor that is capable of out of order execution; however, disclosed aspects can be used in an in-order processor implementation. As such, FIG. 1A depicts functional elements of a microarchitectural implementation of the disclosure, but other implementations are possible. Also, different processor architectures can implement aspects of the disclosure. The names given to some of the functional elements depicted in FIG. 1A may be different among existing processor architectures, but those of ordinary skill would understand from this disclosure how to implement the disclosure on different processor architectures, including those architectures based on pre-existing architectures and even on a completely new architecture. Also, it would be understood that implementations of the disclosure can be provided on processors that execute instructions in order, which support single and/or multi-threading, and so on. As such, the example is not limiting as to a type of processor architectures in which disclosed aspects can be practiced.

Processor 50 includes a fetch unit 52, that is coupled with an instruction cache 54. Instruction cache 54 is coupled with a decode and rename unit 56. Decode and rename unit 56 is coupled with an instruction queue 58 and also with a branch predictor that includes an instruction Translation Lookaside Buffer (iTLB) 60. Instruction queue 58 is coupled with a ReOrder Buffer (ROB) 62 which is coupled with a commit unit 64. ROB 62 is coupled with reservation station(s) 68 and a Load/Store Buffer (LSB) 66. Reservation station(s) 68 are coupled with Out of Order (OO) execution pipeline(s) 70. Execution pipeline(s) 70 and LSB 66 each couple with a register file 72. Register file 72 couples with an L1 data cache(s) 74. L1 cache(s) 74 couple with L2 cache(s) 76. Processor 50 may also have access to further memory hierarchy elements 78. Fetch unit 52 obtains instructions from a memory (e.g., l2 cache 76, which can be a unified cache for data and instructions). Fetch unit 52 can receive directives from branch predictor 60 as to which instructions should be fetched.

Functional elements of processor 50 depicted in FIG. 1A may be sized and arranged differently in different implementations. For example, instruction fetch 52 may fetch 1, 2, 4, 8 or more instructions at a time. Decode and rename 56 may support different numbers of rename registers and queue 58 may support different maximum numbers of entries among implementations. ROB 62 may support different sizes of instruction windows, while reservation station(s) 68 may be able to hold different numbers of instructions waiting for operands and similarly LSB 66 may be able to support different numbers of outstanding reads and writes. Instruction cache 54 may employ different cache replacement algorithms and may employ multiple algorithms simultaneously, for different parts of the cache 54. Defining the capabilities of different microarchitecture elements involve a variety of tradeoffs beyond the scope of the present disclosure.

Implementations of processor 50 may be single threaded or support multiple threads. Implementations also may have Single Instruction Multiple Data (SIMD) execution units. Execution units may support integer operations, floating point operations or both. Additional functional units can be provided for different purposes. For example, encryption offload engines may be provided. FIG. 1A is provided to give context for aspects of the disclosure that follow and not by way of exclusion of any such additional functional elements.

Some portion or all of the elements of processor 50 may be located on a single semiconductor die. In some cases, memory hierarchy elements 78 may be located on another die, which is fabricated using a semiconductor process designed more specifically for the memory technology being used (e.g., DRAM). In some cases, some portion of DRAM may be located on the same die as the other elements and other portions on another die. This is a non-exhaustive enumeration of examples of design choices that can be made for a particular implementation of processor 50.

FIG. 1B depicts that register file 72 of processor 50 may include 32 registers. Each register may be identified by a binary code associated with that register. In a simple example, 00000b identifies Register 0, 11111b identifies Register 31, and registers in between are numbered accordingly. Processor 50 performs computation according to specific configuration information provided by a stream of instructions. These instructions are in a format specified by the architecture of the processor. An instruction may specify one or more source registers, and one or more destination registers for a given operation. The binary codes for the registers are used within the instructions to identify different registers. The registers that can be identified by instructions can be known as “architectural registers”, which present a large portion, but not necessarily all, of the state of the machine available to executing code. Implementations of a particular processor architecture may support a larger number of physical registers than architectural registers. Having a larger number of physical registers aids speculative execution of instructions that refer to the same architectural registers by avoiding false dependencies.

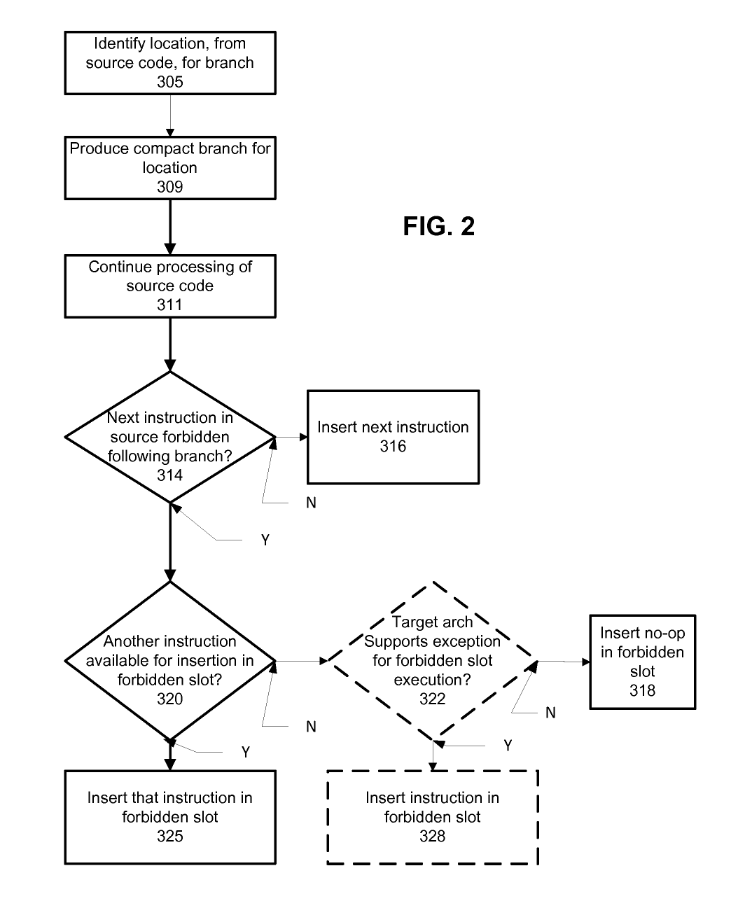

FIG. 2 depicts an example of producing compact branches; such process can be performed by a compiler, such as a pre-execution compiler or a just-in-time compiler. At 305, based on source code being compiled, a location in object code at which a branch is to be inserted is identified. For example, source code may be translated into object code, and a particular line of source code may decompose into one or more separate object code (machine) instructions. Human readable assembly code may contain pseudoinstructions that are translated by an assembler into one or more native machine instructions. This disclosure applies to the translation of source code to human readable assembly language, and to native machine binary code, as well as assembling human readable assembly language into native machine binary code, and subsequent usage of that native machine binary code for configuring a particular machine.

At 309, a compact branch instruction is produced to be inserted in this location. At 311, processing of source code continues. At 314, an instruction slot following the branch instruction is considered; for clarity, this slot is called a “forbidden slot”. A next instruction in machine code representation of the source code can be considered as a candidate for inserting in the forbidden slot. In particular, at 314, a determination whether or not the next instruction is of a type forbidden to be inserted in forbidden slots. If the instruction is not forbidden, then that next instruction is inserted in 316. However, if this next instruction is of a type that is forbidden in a forbidden slot, then, at 320, a determination can be made whether or not another instruction is available to be provided in this slot. If there is, then at 325, such instruction can be located in the forbidden slot. If there is not another instruction that the compiler can identify, which may be inserted, and which is not forbidden, then at 322, it can be determined whether the target architecture will support a forbidden instruction in the forbidden slot. If not, then a no operation can be inserted. Otherwise, at 328, the forbidden instruction can be inserted in the forbidden slot.

The determination at 322 is optional in that implementations may always allow insertion of forbidden instructions in forbidden slots, or never allow such. Some implementations may also provide that the next instruction, regardless of being forbidden in a forbidden slot, is inserted. In such cases, a processor implementation may perform exception checking before and/or after execution of such forbidden instruction and take appropriate action in the presence of exceptions. So, implementations of the disclosure need not strictly forbid instances of particular instruction types from being located immediately after branches, but instead may allow such location, and attempt to execute such instructions, but with additional precautions, conditions, or signal generation. Other implementations may consider whether a subsequent instruction to be generated from source code is an instruction that is forbidden in a forbidden slot, and if so, then simply insert a no operation. These examples show that a variety of implementations of the exemplified process can be provided. Other combinations can be provided, for example, some types of instructions in the forbidden slot can be made to generate an exception, while other types are strictly forbidden.

The following portion of the disclosure includes examples of how compact branches can be encoded. These are only examples, from which a person of ordinary skill can learn in order to produce other implementations. Compact branches can be implemented in a processor that supports virtualized instruction encoding, in which metadata about an instruction is used to decode what operation is intended. Virtualized instruction encoding can be used in processor architectures that have constrained op code space, such that insufficient op code space may be available to maintain both compact branches and branches with delay slots. Such situations can arise, for example, in RISC architectures that may allocate a relatively small number of bits to specify an operation code, for example 5 or 6 bits (in some cases, additional bits may be available for function codes, which specify specific sub-types of a particular instruction, such as an addition or multiplication).

As a brief example of virtual instruction encoding, an order of source registers can be used to select between two different instructions, to be executed, even though the same op code is used. For example, in a conditional branch using two source registers, if a lower register number appears as the first source register, then one variation of condition branch may be selected, and if a higher register number appears as the first source register, then a different variation of condition branch may be executed. Further details concerning virtual instruction encoding, methods pertaining thereto, and processor implementations supporting such are found in U.S. patent application Ser. No. 14/572,186, filed on Dec. 16, 2014, which is incorporated by reference in its entirety herein for all purposes.

| | | | Short Description of |
|---|---|---|---|
| Instruction | | | Action(s) taken by |
| Name | Short Description | Instruction format | processor |
| BEQZALC rt | Branch if equal to 0 | OpCode.rs.rt.ofs16 | Branch if $rt = 0 AND |
| | and link | | link to $r31 |
| BNEZALC rs | Branch if not equal to | OpCode.rs.rt.ofs16 | Branch if $rs != 0 AND |
| | 0 and link | | link to $r31 |
| BLEZALC rt | Branch if less than or | OpCode.00000.rt.ofs16 | Branch if $rt <= 0 AND |
| | equal to 0 and link | | link to $r31 |
| BGEZALC rt | Branch if greater than | OpCode.rs.rt.ofs16 | Branch if $rt >= 0 AND |
| | or equal to 0 and link | | link to $r31 |
| BGTZALC rt | Branch if greater than | OpCode.00000.rt.ofs16 | Branch if $rt > 0 AND |
| | 0 and link | | link to $r31 |
| BLTZALC rt | Branch if less than 0 | OpCode.rs.rt.ofs16 | Branch if $rt < 0 AND |
| | and link | | link to $r31 |
| BEQC rs, rt | Branch if equal | OpCode.rs.rt.ofs16 | Branch if $rs = $rt |
| BNEC rs, rt | Branch if not equal | OpCode.rs.rt.ofs16 | Branch if $rs != $rt |
| BLEZC rt | Branch if less than or | OpCode.00000.rt.ofs16 | Branch if $rt <= 0 |
| | equal to 0 | | |
| BGEZC rt | Branch if greater than | OpCode.rs.rt.ofs16 | Branch if $rt >= 0 |
| | or equal to 0 | | |
| BGTZC rt | Branch if greater than 0 | OpCode.00000.rt.ofs16 | Branch if $rt >= 0 |
| BLTZC rt | Branch if less than 0 | OpCode.rs.rt.ofs16 | Branch if $rt < 0 |
| BGTC rt, rs | Branch if greater than | OpCode.rs.rt.ofs16 | Branch if $rt > rs |
| BLTC rs, rt | Branch if less than | OpCode.rs.rt.ofs16 | Branch if $rs < $rt |
| BBEC rs, rt | Branch if greater than | OpCode.rs.rt.ofs16 | Branch if $rs >= $rt, |
| | or equal to, unsigned | | unsigned |
| BSEC rt, rs | Branch if less than or | OpCode.rs.rt.ofs16 | Branch if $rt <= $rs |
| | equal to, unsigned | | Unsigned |
| BSTC rs, rt | Branch if greater than, | OpCode.rs.rt.ofs16 | Branch if $rs > $rt, |
| | unsigned | | unsigned |
| BBTC rt, rs | Branch if less than, | OpCode.rs.rt.ofs16 | Branch if $rt < $rs |
| | unsigned | | Unsigned |
| BEQZC rs | Branch if equal to zero, | OpCode.rs.ofs21 | Branch if $rs = 0, 21 bit |
| | larger immediate | | offset range |
| BNEZC rs | Branch if not equal to | OpCode.rs.ofs21 | Branch if $rs != 0, 21 bit |
| | zero, larger immediate | | offset range |
| BC | Branch | OpCode.ofs26 | Branch Compact OFFSET |
| BALC | Branch and link | OpCode.ofs26 ( ) | Branch and Link Compact |

It would be understood by those of ordinary skill that the above example instructions are exemplary, and fewer, more or different branch instructions can be implemented in a particular processor implementation. Also, the pneumonics used to refer to a particular operation are exemplary, rather than required.

A processor can be designed with a decode unit that implements these disclosures. However, the processor still would operate under configuration by code generated from an external source (e.g., a compiler, an assembler, or an interpreter). Such code generation can include transforming source code in a high level programming language into object code (e.g., an executable binary or a library that can be dynamically linked), or producing assembly language output, which could be edited, and ultimately transformed into object code. Other situations may involve transforming source code into an intermediate code format (e.g., a “byte code” format) that can be translated or interpreted, such as by a Just In Time (JIT) process, such as in the context of a Java® virtual machine. Any such example code generation aspect can be used in an implementation of the disclosure. Additionally, these examples can be used by those of ordinary skill in the art to understand how to apply these examples to different circumstances.

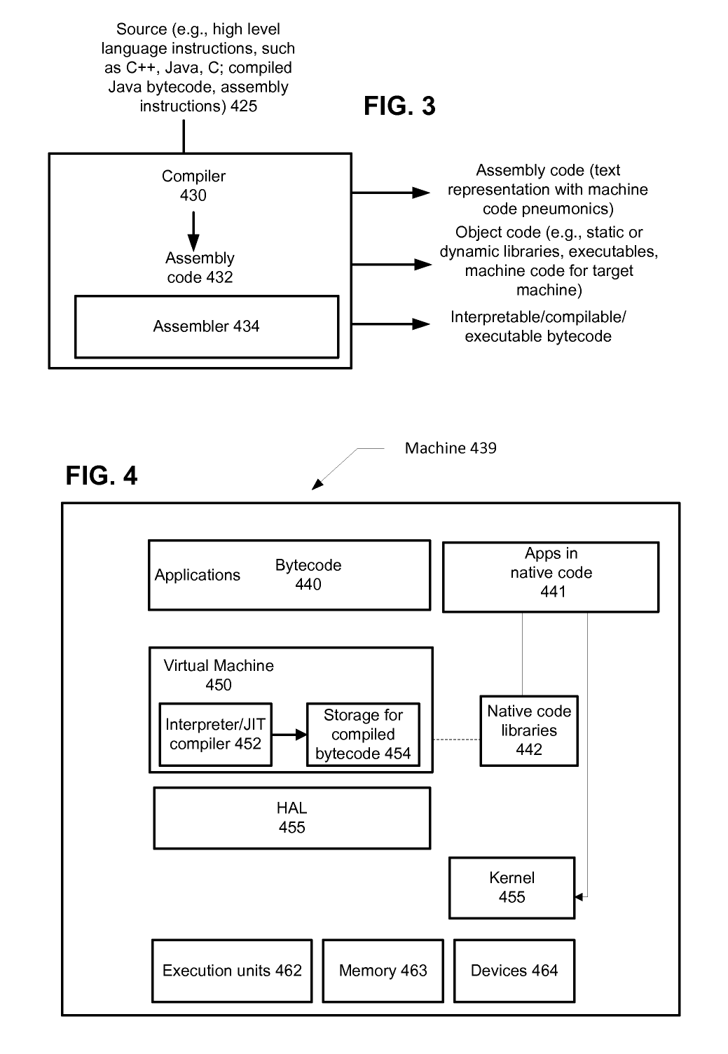

FIG. 3 depicts a diagram in which a compiler 430 includes an assembler 434. As an option, compiler 430 can generate assembly code 432 according to the disclosure. This assembly code could be outputted. Such assembly code may be in a text representation that includes pneumonics for the various instructions, as well as for the operands and other information used for the instruction. These pneumonics can be chosen so that the actual operation that will be executed for each assembly code element is represented by the pneumonic. However, in some circumstances, a single pneuomonic may not have an exact correspondence to a single machine operation, and a compiler or assembler may translate that kind of assembly language instruction into one or more operations that can be performed natively on a target processor architecture.

Also, if using virtual instruction encoding, two assembly language instructions that would be logically equivalent may ultimately cause a processor to perform logically different operations. For example, “branch if Rs=Rt” is logically equivalent to “branch if Rt=Rs”. However, a virtual instruction encoding scheme may interpret one of these statements as a different operation. As such, a compiler or assembler may output human readable assembly language code that describes the operation that will actually be performed during execution, but also output object code that is directly usable by the machine.

In other words, even though underlying binary opcode identifiers within a binary code may be the same, when representing that binary code in text assembly language, the pneumonics selected would be selected also based on the other elements of each assembly language element, such as relative register ordering, that affect what operation will be performed by the processor and not simply a literal translation of the binary opcode identifier. FIG. 3 also depicts that compiler can output object code, and bytecode, which can be interpretable, compilable or executable on a particular architecture. Here, “bytecode” is used to identify any form of intermediate machine readable format, which in many cases is not targeted directly to a physical processor architecture, but to an architecture of a virtual machine, which ultimately performs such execution. A physical processor architecture can be designed to execute any such bytecode, however, and this disclosure makes no restriction otherwise. In this disclosure, object code refers to an output of one or more of compilation and assembly, which includes bytecode as well as machine language. As such, the term “object code” does not exclude the possibility that a human may be able to read and understand it.

FIG. 4 depicts a block diagram of an example machine 439 in which aspects of the disclosure may be employed. A set of applications are available to be executed on machine 439. These applications are encoded in bytecode 440. Applications also can be represented in native machine code; these applications are represented by applications 441. Applications encoded in bytecode are executed within virtual machine 450. Virtual machine 450 can include an interpreter and/or a Just In Time (JIT) compiler 452. Virtual machine 450 may maintain a store 454 of compiled bytecode, which can be reused for application execution. Virtual machine 450 may use libraries from native code libraries 442. These libraries are object code libraries that are compiled for physical execution units 462. A Hardware Abstraction Layer 455 provides abstracted interfaces to various different hardware elements, collectively identified as devices 464. HAL 455 can be executed in user mode. Machine 439 also executes an operating system kernel 455.

Devices 464 may include IO devices and sensors, which are to be made available for use by applications. For example, HAL 455 may provide an interface for a Global Positioning System, a compass, a gyroscope, an accelerometer, temperature sensors, network, short range communication resources, such as Bluetooth or Near Field Communication, an RFID subsystem, a camera, and so on.

Machine 439 has a set of execution units 462 which consume machine code which configures the execution units 462 to perform computation. Such machine code thus executes in order to execute applications originating as bytecode, as native code libraries, as object code from user applications, and code for kernel 455. Any of these different components of machine 439 can be implemented using the virtualized instruction encoding disclosures herein.

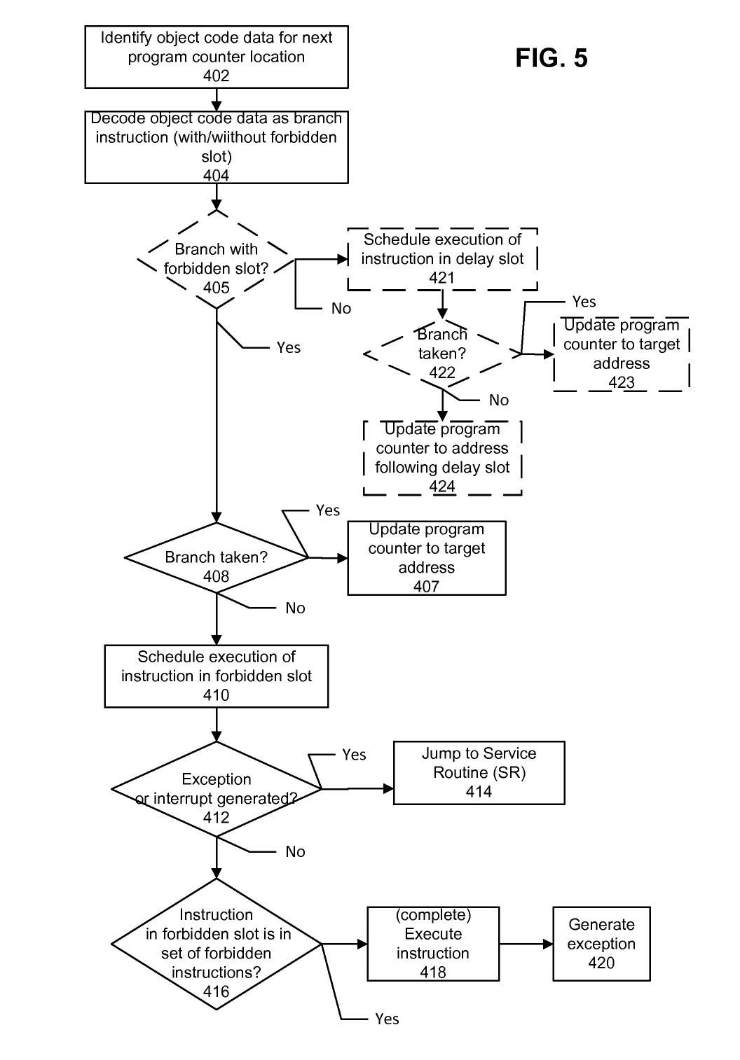

FIG. 5 depicts a process by which machine readable code can be processed by a processor implementing the disclosure. FIG. 5 depicts a branch decoding process for a processor that can support execution of branch instructions that have delay slots and those without delay slots (and which can have forbidden slot, instead, in an example implementation). Portions of the process depicted in FIG. 5 that have dashed lines are those which may not be included, for processors that do not support branches with delay slots.

At 402, code data for a next program counter location is identified and decoded, at 404, to result in a branch instruction. Of course, other machine readable code may be decoded at 404, which decode to other instructions, and these may be handled according to a procedure appropriate for each such instruction. In one example, a machine may support executing branch instructions that have delay slots and those that do not, within the same instruction stream. In some implementations, a machine may be configured at run time, or for a specific item of machine code, to execute branch instructions to either have or not have a delay slot. Some implementations may support the forbidden slot disclosures presented herein, for executing branches without delay slots.

At 405, it is determined whether the branch instruction has a forbidden slot (and not a delay slot), or has a delay slot.

If the branch has a forbidden slot (not a delay slot), then the process determines whether the branch is taken or not, at 408. If the branch has a delay slot, then execution of the instruction in the delay slot is scheduled without determining whether the branch is taken, at 421. At 422, it is determined whether the branch is taken, and if so, then the program counter is updated to a branch target address, and execution proceeds from there (with the effect of the delay slot instruction being available to architectural state of the processor). If the branch is not taken, then the program counter is incremented to begin executing the instruction following the delay instruction (again, with architectural state reflecting execution of the delay slot instruction).

If the branch is not one with a delay slot, then at 408 it is determined whether the branch is taken. If the branch is taken, then a program counter is updated to a target address of the branch, at 407. If the branch is not taken, then the instruction in a forbidden slot following the branch can be scheduled for execution at 410. At 412, generation of an exception or interrupt is detected during execution of the instruction in the forbidden slot. If there is such an exception or interrupt, then the program counter can be set to a service routine location, at 414. In the absence of an exception or interrupt, it can still be determined, at 416, whether the instruction in the forbidden slot is a forbidden instruction. If so, then after executing that instruction (completing execution at 418), an exception will be generated at 420. Here, “determining” does not imply or require that it be absolutely determined whether or not a branch will be taken, but rather, a branch can be speculatively determined as taken or not.

FIG. 5 thus depicts a branch instruction decoding and processing example, for a processor that supports at least branch instructions having forbidden slots, and which also may support branch instructions that have delay slots. Implementations of the process depicted in FIG. 5 may vary according to particular criteria, and each individual action may not make to a distinct action performed in every processor implementation of the disclosure. For example, the decoding at 404 may also perform the determination at 405 concerning what kind of branch instruction is being executed. The branch taken determinations at 422 and 408 may be implemented as a single determination, even though depicted separately, in order to accurately depict the difference in processing between an instruction in a forbidden slot versus an instruction in a delay slot. The order of actions depicted in FIG. 5 does not imply a necessary order in which such actions are performed in different implementations. For example, a processor may predict that the branch at a particular program counter is taken and leads to a particular target address, before a final decision on branch taken (at 408, 422) is performed, and before a final target address is determined. By further example, an instruction in a forbidden slot may be speculatively executed before a branch is determined as taken or not. These examples show that the decoding and execution process of FIG. 5 does not specifically encompass all the possible variations among processor architectures that may be provided, relating to out of order execution, instruction trace caching, branch target buffering, branch prediction, and so on. A person of ordinary skill would be able to adapt these disclosures to a specific processor architecture, to account for these various enhancements.

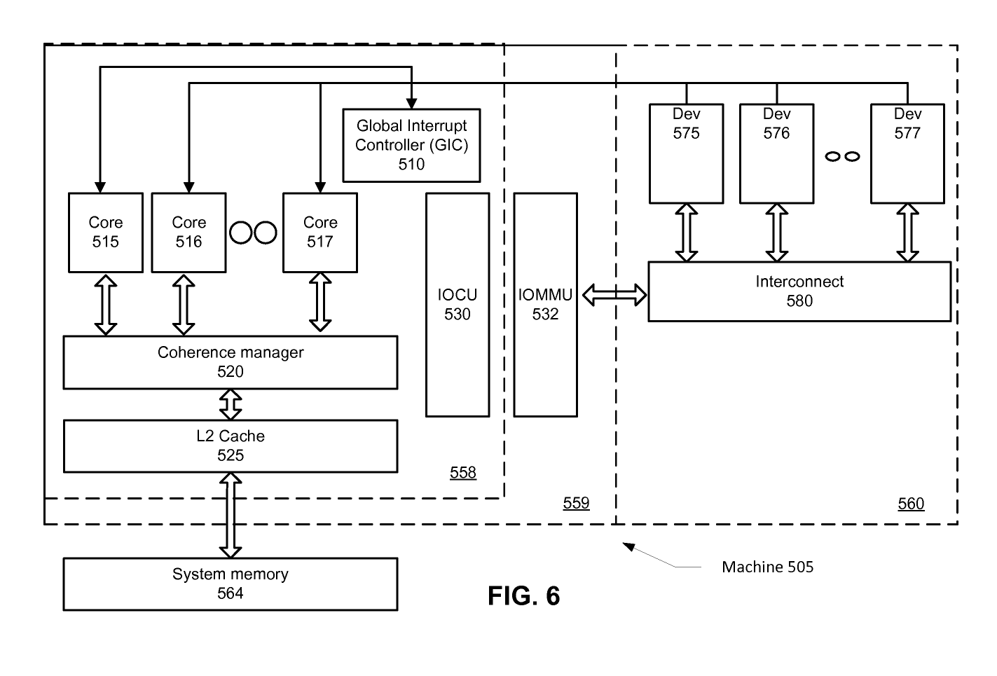

FIG. 6 depicts an example of a machine 505 that implements execution elements and other aspects disclosed herein. FIG. 6 depicts that different implementations of machine 505 can have different levels of integration. In one example, a single semiconductor element can implement a processor module 558, which includes cores 515-517, a coherence manager 520 that interfaces cores 515-517 with an L2 cache 525, an I/O controller unit 530 and an interrupt controller 510. A system memory 564 interfaces with L2 cache 525. Coherence manager 520 can include a memory management unit and operates to manage data coherency among data that is being operated on by cores 515-517. Cores may also have access to L1 caches that are not separately depicted. In another implementation, an IO Memory Management Unit (IOMMU) 532 is provided. IOMMU 532 may be provided on the same semiconductor element as the processor module 558, denoted as module 559. Module 559 also may interface with IO devices 575-577 through an interconnect 580. A collection of processor module 558, which is included in module 559, interconnect 580, and IO devices 575-577 can be formed on one or more semiconductor elements. In the example machine 505 of FIG. 7, cores 515-517 may each support one or more threads of computation, and may be architected according to the disclosures herein.

Modern general purpose processors regularly require in excess of two billion transistors to be implemented, while graphics processing units may have in excess of five billion transistors. Such transistor counts are likely to increase. Such processors have used these transistors to implement increasing complex operation reordering, prediction, more parallelism, larger memories (including more and bigger caches) and so on. As such, it becomes necessary to be able to describe or discuss technical subject matter concerning such processors, whether general purpose or application specific, at a level of detail appropriate to the technology being addressed. In general, a hierarchy of concepts is applied to allow those of ordinary skill to focus on details of the matter being addressed.

For example, high level features, such as what instructions a processor supports conveys architectural-level detail. When describing high-level technology, such as a programming model, such a level of abstraction is appropriate. Microarchitectural detail describes high level detail concerning an implementation of an architecture (even as the same microarchitecture may be able to execute different ISAs). Yet, microarchitectural detail typically describes different functional units and their interrelationship, such as how and when data moves among these different functional units. As such, referencing these units by their functionality is also an appropriate level of abstraction, rather than addressing implementations of these functional units, since each of these functional units may themselves comprise hundreds of thousands or millions of gates. When addressing some particular feature of these functional units, it may be appropriate to identify substituent functions of these units, and abstract those, while addressing in more detail the relevant part of that functional unit.

Eventually, a precise logical arrangement of the gates and interconnect (a netlist) implementing these functional units (in the context of the entire processor) can be specified. However, how such logical arrangement is physically realized in a particular chip (how that logic and interconnect is laid out in a particular design) still may differ in different process technology and for a variety of other reasons. Many of the details concerning producing netlists for functional units as well as actual layout are determined using design automation, proceeding from a high level logical description of the logic to be implemented (e.g., a “hardware description language”).

The term “circuitry” does not imply a single electrically connected set of circuits. Circuitry may be fixed function, configurable, or programmable. In general, circuitry implementing a functional unit is more likely to be configurable, or may be more configurable, than circuitry implementing a specific portion of a functional unit. For example, an Arithmetic Logic Unit (ALU) of a processor may reuse the same portion of circuitry differently when performing different arithmetic or logic operations. As such, that portion of circuitry is effectively circuitry or part of circuitry for each different operation, when configured to perform or otherwise interconnected to perform each different operation. Such configuration may come from or be based on instructions, or microcode, for example.

In all these cases, describing portions of a processor in terms of its functionality conveys structure to a person of ordinary skill in the art. In the context of this disclosure, the term “unit” refers, in some implementations, to a class or group of circuitry that implements the functions or functions attributed to that unit. Such circuitry may implement additional functions, and so identification of circuitry performing one function does not mean that the same circuitry, or a portion thereof, cannot also perform other functions. In some circumstances, the functional unit may be identified, and then functional description of circuitry that performs a certain feature differently, or implements a new feature may be described. For example, a “decode unit” refers to circuitry implementing decoding of processor instructions. The description explicates that in some aspects, such decode unit, and hence circuitry implementing such decode unit, supports decoding of specified instruction types. Decoding of instructions differs across different architectures and microarchitectures, and the term makes no exclusion thereof, except for the explicit requirements of the claims. For example, different microarchitectures may implement instruction decoding and instruction scheduling somewhat differently, in accordance with design goals of that implementation. Similarly, there are situations in which structures have taken their names from the functions that they perform. For example, a “decoder” of program instructions, that behaves in a prescribed manner, describes structure supports that behavior. In some cases, the structure may have permanent physical differences or adaptations from decoders that do not support such behavior. However, such structure also may be produced by a temporary adaptation or configuration, such as one caused under program control, microcode, or other source of configuration.

Different approaches to design of circuitry exist, for example, circuitry may be synchronous or asynchronous with respect to a clock. Circuitry may be designed to be static or be dynamic. Different circuit design philosophies may be used to implement different functional units or parts thereof. Absent some context-specific basis, “circuitry” encompasses all such design approaches.

Although circuitry or functional units described herein may be most frequently implemented by electrical circuitry, and more particularly, by circuitry that primarily relies on a transistor implemented in a semiconductor as a primary switch element, this term is to be understood in relation to the technology being disclosed. For example, different physical processes may be used in circuitry implementing aspects of the disclosure, such as optical, nanotubes, micro-electrical mechanical elements, quantum switches or memory storage, magnetoresistive logic elements, and so on. Although a choice of technology used to construct circuitry or functional units according to the technology may change over time, this choice is an implementation decision to be made in accordance with the then-current state of technology. This is exemplified by the transitions from using vacuum tubes as switching elements to using circuits with discrete transistors, to using integrated circuits, and advances in memory technologies, in that while there were many inventions in each of these areas, these inventions did not necessarily fundamentally change how computers fundamentally worked. For example, the use of stored programs having a sequence of instructions selected from an instruction set architecture was an important change from a computer that required physical rewiring to change the program, but subsequently, many advances were made to various functional units within such a stored-program computer.

Although some subject matter may have been described in language specific to examples of structural features and/or method steps, it is to be understood that the subject matter defined in the appended claims is not necessarily limited to these described features or acts. For example, a given structural feature may be subsumed within another structural element, or such feature may be split among or distributed to distinct components. Similarly, an example portion of a process may be achieved as a by-product or concurrently with performance of another act or process, or may be performed as multiple separate acts in some implementations. As such, implementations according to this disclosure are not limited to those that have a 1:1 correspondence to the examples depicted and/or described.

Above, various examples of computing hardware and/or software programming were explained, as well as examples how such hardware/software can intercommunicate. These examples of hardware or hardware configured with software and such communications interfaces provide means for accomplishing the functions attributed to each of them. For example, a means for performing implementations of software processes described herein includes machine executable code used to configure a machine to perform such process. In particular, a compiler may comprise a means for executing a compilation algorithm according to the example of FIG. 2. Some aspects of the disclosure pertain to processes carried out by limited configurability or fixed function circuits and in such situations, means for performing such processes include one or more of special purpose and limited-programmability hardware. Such hardware can be controlled or invoked by software executing on a general purpose computer.

Aspects of functions, and methods described and/or claimed may be implemented in a special purpose or general-purpose computer including computer hardware, as discussed in greater detail below. Such hardware, firmware and software can also be embodied on a video card or other external or internal computer system peripherals. Various functionality can be provided in customized FPGAs or ASICs or other configurable processors, while some functionality can be provided in a management or host processor. Such processing functionality may be used in personal computers, desktop computers, laptop computers, message processors, hand-held devices, multi-processor systems, microprocessor-based or programmable consumer electronics, game consoles, network PCs, minicomputers, mainframe computers, mobile telephones, PDAs, tablets and the like.

In addition to hardware embodiments (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer readable code, program code, instructions and/or data disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), GDSII databases, hardware description languages (HDL) including Verilog HDL, VHDL, SystemC Register Transfer Level (RTL) and so on, or other available programs, databases, and/or circuit (i.e., schematic) capture tools. Embodiments can be disposed in computer usable medium including non-transitory memories such as memories using semiconductor, magnetic disk, optical disk, ferrous, resistive memory, and so on.

As specific examples, it is understood that implementations of disclosed apparatuses and methods may be implemented in a semiconductor intellectual property core, such as a microprocessor core, or a portion thereof, embodied in a Hardware Description Language (HDL)), that can be used to produce a specific integrated circuit implementation. A computer readable medium may embody or store such description language data, and thus constitute an article of manufacture. A non-transitory machine readable medium is an example of computer readable media. Examples of other embodiments include computer readable media storing Register Transfer Language (RTL) description that may be adapted for use in a specific architecture or microarchitecture implementation. Additionally, the apparatus and methods described herein may be embodied as a combination of hardware and software that configures or programs hardware.

Also, in some cases terminology has been used herein because it is considered to more reasonably convey salient points to a person of ordinary skill, but such terminology should not be considered to impliedly limit a range of implementations encompassed by disclosed examples and other aspects.

Also, a number of examples have been illustrated and described in the preceding disclosure. By necessity, not every example can illustrate every aspect, and the examples do not illustrate exclusive compositions of such aspects. Instead, aspects illustrated and described with respect to one figure or example can be used or combined with aspects illustrated and described with respect to other figures. As such, a person of ordinary skill would understand from these disclosures that the above disclosure is not limiting as to constituency of embodiments according to the claims, and rather the scope of the claims define the breadth and scope of inventive embodiments herein. The summary and abstract sections may set forth one or more but not all exemplary embodiments and aspects of the invention within the scope of the claims.

I claim:

1. Circuitry for decoding instruction data into operations to be performed in a microprocessor, the circuitry comprising:
decode logic configured for interpreting portions of instruction data as respective operations to be performed in the processor, wherein
each portion of instruction data corresponds to a respective program counter location, the operations to be performed conform to an instruction set architecture that comprises a first set of branch instructions that have a delay slot, and a second set of branch instructions that do not have a delay slot,
the decode logic is further configured to cause an instruction found in a program counter location directly after an instance of a branch instruction with a delay slot to be executed, regardless of an outcome of executing the instance of the branch instruction, and
the decode logic is further configured to cause an instruction found in a program counter location directly after an instance of a branch instruction without a delay slot to be executed, only if an outcome of executing the instance of the branch instruction without a delay slot does not branch around that instruction.

2. The circuitry of claim 1, wherein the decode logic is further configured to cause an exception if the instruction found in the program counter location directly after the instance of a branch instruction without a delay slot is itself a branch instruction.

3. The circuitry of claim 1, wherein the instance of the instruction without a delay slot is represented by 32 bits of data, and includes at least 21 bits for defining an immediate value that is used to calculate a target address of the branch, if the branch is taken.

4. The circuitry of claim 3, wherein the instance of the instruction without a delay slot includes 26 bits for defining the immediate value.

5. The circuitry of claim 1, wherein the branch instruction without the delay slot is a branch and link instruction that causes storage of a return address in a pre-determined register of a set of registers that are available to be referenced by instructions in the instruction set architecture.

6. The circuitry of claim 1, wherein the data includes 26 bits for defining the immediate value.

7. The circuitry of claim 1, wherein the branch instruction control is a branch and link instruction interpretable to cause storage of a return address in a pre-determined register of a set of registers that are available to be referenced by instructions in a target instruction set architecture.

8. A system comprising the circuitry of claim 1, the system comprising a just-in-time compiler, configured for accepting byte code targeted to a virtual machine and outputting object code for execution on a microprocessor having a pre-determined instruction set architecture.

9. A processor, comprising:
a decoder coupled to a source of instruction data representing instructions to be executed in the processor, the decode unit for interpreting portions of the instruction data as respective operations to be performed in the processor, wherein
each portion of instruction data corresponds to a respective program counter location,
the operations to be performed conform to an instruction set architecture that comprises a first set of branch instructions that have a delay slot, and a second set of branch instructions without a delay slot; and
a scheduler to schedule operations on an execution unit, in accordance with the instruction data, the scheduler configured,
for each instance of a branch instruction with a delay slot, to cause an instruction found in a program counter location directly after that instance to be executed without regard to an outcome of the branch instruction, and
for each instance of a branch instruction without a delay slot, to cause execution of the instruction found in a program counter location directly after that instance only if an outcome of the branch instruction does not branch around the instruction found in a program counter location directly after that instance of a branch instruction without a delay slot.

10. The processor of claim 9, wherein the branch instruction without a delay slot is represented by 32 data bits, including at least 21 bits for defining an immediate value that is used for calculating a branch target address.

11. The processor of claim 10, wherein the immediate value is defined by 26 bits of the 32 bit instruction.

12. The processor of claim 9, wherein the branch instruction without a delay slot is a branch and link instruction that causes storage of a return address in a pre-determined register of a set of architectural registers available to be referenced by instructions in the instruction set architecture.

13. The processor of claim 9, wherein the execution unit is configured to generate an exception responsive to an instruction from the program counter location directly following a branch instruction without a delay slot, if that instruction is of a type from a pre-determined set of instruction types.

14. The processor of claim 13, wherein the execution unit is configured to generate the exception after execution of the instruction, regardless of an outcome of executing the instruction.

15. A non-transitory machine readable medium storing instructions for executing a program compilation process, comprising:
inputting a portion of source code, for which an object code is to be generated;
identifying a location in the portion of source code in which a branch of control is to be inserted in a corresponding location in the object code;
producing data representing the branch of control for insertion in the corresponding location in the object code;
identifying an instruction for insertion in a location in the object code directly after the location where the branch of control was inserted, the identifying comprising excluding from consideration instructions from an enumerated set of forbidden instruction types and including only instructions that are on a code path that will be executed if the branch is not taken; and
storing, on a non-transitory medium, machine readable data representing the identified instruction for insertion in the location in the object code directly after the location where the branch of control was inserted.

16. The non-transitory machine readable medium of claim 15, wherein the program compilation process is configured to produce 32 bits of data representing the branch of control, and include at least 21 bits for defining an immediate value that is used to calculate a target address of the branch, if the branch is taken.

17. The non-transitory machine readable medium of claim 16, wherein the data includes 26 bits for defining the immediate value.

18. The non-transitory machine readable medium of claim 15, wherein the branch of control is a branch and link instruction that causes storage of a return address in a pre-determined register of a set of registers that are available to be referenced by instructions in a target instruction set architecture.

19. The non-transitory machine readable medium of claim 15, wherein the program compilation process operates as a just-in-time compiler, accepting byte code targeted to a virtual machine and outputting object code for execution on a specific microprocessor.
